(19) United States
(12) Patent Application Publication
(10) Pub. No.: US 2014/0151265 A1
(43) Pub. Date: Jun. 5, 2014

(54) CATALYST FOR USE IN PRODUCTION OF SATURATED HYDROCARBONS FROM SYNTHESIS GAS

(71) Applicants: Qingjie Ge, Dalian (CH); Xiangang Ma, Dalian (CH); Hengyong Xu, Dalian (CH)

(72) Inventors: Qingjie Ge, Dalian (CH); Xiangang Ma, Dalian (CH); Hengyong Xu, Dalian (CH)

(73) Assignees: BP p.l.c., London (GB); DALIAN INSTITUTE OF CHEMICAL PHYSICS, CHINESE ACADEMY OF SCIENCES, Dalian, Liaoning Province (CN)

(21) Appl. No.: 14/113,024

(22) PCT Filed: Apr. 21, 2011
(86) PCT No.: PCT/CN11/00697

§ 371 Date: Feb. 6, 2014

(51) Int. Cl. B01J 29/85; C10G 2/00

(52) U.S. Cl. CPC B01J 29/85; C10G 2/331
USPC 208/14; 502/60; 502/74; 518/715; 518/709; 422/630

(57) ABSTRACT

A catalyst composition is provided for use in the conversion of carbon oxide(s) to saturated hydrocarbons. The catalyst composition comprises a carbon oxide(s) conversion catalyst; and a dehydration/hydrogenation catalyst comprising a silicoalumino phosphate (SAPO) molecular sieve and a metal M, for example Pd. In one embodiment, the target saturated hydrocarbons include LPG, the SAPO comprises SAPO-5 and/or SAPO-37.

This invention relates to a catalyst. Aspects of the invention relate to a catalyst for use in the production of saturated hydrocarbons. Aspects of the invention relate to multifunctional catalysts, for example for use in a process for the production of saturated hydrocarbons from synthesis gas. Aspects of the invention provide a method of preparation of a multifunctional catalyst. Some examples of the invention relate to the production of liquefied petroleum gas from synthesis gas. Some aspects of the invention may also find application in relation to the production of liquid fuels for example gasoline. Some aspects of the invention may find application in relation to a method and/or apparatus for the production of saturated hydrocarbons.

In recent years, the dominance of natural gas and petroleum as feedstocks has diminished. New feedstocks such as tar sands, coal, biomass and municipal waste have been increasing in importance. The diversity of feedstocks has driven the development of synthesis gas (syngas) routes to replace conventional routes to hydrocarbons from natural gas and petroleum.

Liquefied petroleum gas (LPG), a general description of propane and butane, has environmentally relatively benign characteristics and has been widely used as a so-called clean fuel. Conventionally, LPG has been produced as a byproduct of liquefaction of natural gas, or as a byproduct of refinery operations. LPG obtained by such methods generally consists of mainly propane and n-butane mixtures. Alternatively sources for LPG would be desirable. Synthesis of LPG from syngas is potentially a useful route as it would allow for the conversion of diverse feedstocks, for example natural gas, biomass, coal, tar sands and refinery residues.

One synthesis route to hydrocarbons uses the Fischer-Tropsch synthesis reaction. However, this can be disadvantageous in that the product hydrocarbons will follow Anderson-Schulz-Flory distribution, and as a result the selectivity to LPG would be relatively limited. In particular, such a process would generally produce significant amounts of undesirable methane together with higher linear hydrocarbons.

Therefore a new synthesis method to produce LPG would be desirable.

Processes exist for selectively converting syngas to for example methane or methanol. The conversion of methanol to C₂ and C₃ products as exemplified in the methanol to olefins (MTO) and methanol to propylene (MTP) is well known, for example as described in U.S. Pat. No. 6,613,951. However, in some cases, the selectivity may be limited and products may consist predominantly of C₂ and C₃ olefins.

The methanol to gasoline (MTG) process as developed by Mobil allows access to a mixed product rich in aromatics and olefins.

Neither of these processes is selective to LPG.

Recently, several investigations have been made relating to a process for the production LPG from syngas. Some investigations involve multifunctional catalyst systems. For example Zhang Q, et al. Catalysis Letters Vol 102, No 1-2 Jul. 2005, describes hybrid catalysts based on Pd—Ca/SiO₂ and zeolite, and on Cu—Zn/zeolite.

Qingjie Ge et al, Journal of Molecular Catalysis A: Chemical 278 (2007) 215-219, describes the reaction of synthesis gas to produce LPG using a mixed catalyst system in a single bed comprising a Pd—Zn—Cr methanol synthesis catalyst and a Pd-loaded zeolite for dehydration of methanol and dimethyl ether (DME).

The selective synthesis of LPG from syngas could be carried out over a hybrid catalyst composed of a methanol synthesis catalyst and modified zeolites. For example, Chinese Patent Application No. 1054202 of Ding describes a catalyst composed of Cu—ZnO—Al₂O₃ (or Cu—Zn/Cr₂O₃) with H—Y molecular sieve catalysts for CO hydrogenation to propane which is said to exhibit a good catalytic performance with 64% CO conversion and 96% propane formation in hydrocarbons.

Japanese Patent Application No. 2009195815 of Li describes a hybrid catalyst composed of Cu—ZnO methanol synthesis catalysts with Pd modified β-zeolite as well as one or more of Cu, Cr, Mn and Fe for syngas conversion to LPG in a slurry-bed reactor.

Japanese Patent Application No. 2007181755 of Fujimoto describes a catalyst containing Pd—Ca/SiO₂ with β-zeolite for syngas conversion to LPG.

Chinese Patent Application No. 101415492A, also of Fujimoto describes Cu—ZnO/Pd-β catalysts for syngas conversion to LPG.

The above-mentioned catalysts exhibit some catalytic performance for synthesis gas to LPG reaction.

However, due to several reasons including for example issues relating to stability, high content of noble-metal, and low reaction performance, there remains a need for an alternative catalyst for the conversion of syngas to C₃ and higher hydrocarbons. In particular, there is a need for a catalyst suitable for the large-scale application of syngas to LPG conversion processes.

Some aspects of the present invention seek to solve or at least mitigate one or more of these and/or other problems and/or to provide an alternative catalyst for use in syngas to saturated hydrocarbon conversion processes.

A catalyst system for the production of saturated hydrocarbons, in particular C₃ and higher hydrocarbons, combining an improved selectivity and high activity with improved lifetime would be desirable.

According to an aspect of the invention there is provided a catalyst composition for use in the conversion of carbon oxide(s) to saturated hydrocarbons, the catalyst composition comprising:
a) a carbon oxide(s) conversion catalyst; and
b) a dehydration/hydrogenation catalyst comprising a silicoalumino phosphate (SAPO) molecular sieve and a metal M.

It has been identified by the inventors that a hybrid catalyst including a carbon oxide(s) conversion catalyst together with a SAPO molecular sieve and an active metal can be used in the conversion of carbon oxide(s) to saturated hydrocarbons.

In aspects of the invention, a wide range of SAPOs can be used as the SAPO molecular sieve. For example, the SAPO may comprise one or more of SAPO-5, SAPO-37, SAPO-34, SAPO-11 and/or other SAPOs. As described further below, in some examples, some SAPOs are preferred over other SAPOs. The dehydration/hydrogenation catalyst may further include other components. The dehydration/hydrogenation catalyst may further include other molecular sieves, for example zeolites, for example aluminosilicate compositions.

Silicoalumino phosphates are known to form crystalline structures having micropores which compositions can be used as molecular sieves for example as adsorbents or catalysts in chemical reactions. SAPO materials include microporous materials having micropores formed by ring structures, including 8, 10 or 12-membered ring structures. Some SAPO compositions which have the form of molecular sieves have a three-dimensional microporous crystal framework structure of PO₂⁺, AlO₂⁻, and SiO₂ tetrahedral units. The ring structures give rise to an average pore size of from about 0.3 nm to about 1.5 nm or more. Examples of SAPO molecular sieves and methods for their preparation are described in U.S. Pat. No. 4,440,871 and U.S. Pat. No. 6,685,905 (the content of which are incorporated herein by reference).

In examples of the present invention, SAPO compositions modified by the addition of a metal M are used as dehydration/hydrogenation catalysts. It is anticipated that various SAPO compositions would be suited for use in the dehydration/hydrogenation catalysts of the present invention. Some SAPO compositions will however be preferred and will be more advantageous in particular in relation to the selectivity of the conversion to C₃ and higher hydrocarbons, for example SAPO-5 and SAPO-37.

In aspects of the invention, it has been identified that some SAPO molecular sieves are preferred for use in the dehydration/hydrogenation catalyst in examples where particular hydrocarbons are included in the target products.

For example, where the target hydrocarbon products include LPG, it has been identified that preferred SAPO molecular sieves include SAPO-5 and SAPO-37. Thus the SAPO molecular sieve may include SAPO-5 and/or SAPO-37.

In some examples, for example where the target hydrocarbon products include saturated C₃ and higher hydrocarbons, it is preferred that the dehydration/hydrogenation catalyst comprises a SAPO having an average pore size of at least 0.7 nm. For example, the dehydration/hydrogenation catalyst may comprise a SAPO having an average pore size of at least 0.73 nm. For example, the catalyst may include a SAPO with a average pore size of about 0.73×0.73 nm (for example SAPO-5) and/or about 0.74×0.74 nm (for example SAPO-37). It has been found that catalyst including SAPO compositions having such pore size can show high selectivity for LPG (C₃ and C₄). For selectivity for other products, different pore sizes may be desirable.

In some examples the average pore size may be less than about 0.8 nm, for example less than about 0.76 nm. The average pore size may be between about 0.72 and 0.75 nm.

In some examples of the present invention, SAPO compositions having larger pore sizes, for example formed of 10 and/or 12 (or more) membered rings are preferred. For example, where LPG is a target product, SAPO compositions including 10 and/or 12 membered rings may be included in the catalyst composition. In some examples, SAPO components having an average pore size greater than about 0.7 nm are preferred. In some examples, for example where the SAPO includes SAPO-5, the average pore size of the SAPO may be about 0.73×0.73 nm. In some examples, the pore size is preferably determined as the diameter of pores of the composition. In some examples of the invention, the average pore size of the SAPO will be greater than about 7.2 nm. In some examples, the average pore size of the SAPO will be greater than about 0.8 nm, for example greater than about 0.9 nm. Without wishing to be bound by any particular theory, it is believed that the presence of the larger pore sizes may favour the formation of the higher products. In examples where gasoline fractions are sought as the products, larger pore size, for example greater than about 0.8 nm or 0.9 nm will be preferred in some examples.

SAPO-5 has a relatively large pore size of 0.73×0.73 nm. This pore size is similar to that of Y-zeolite which has a pore size of about 0.74 nm×0.74 nm. It has been reported that Y-zeolite may show a good selectivity for C₃ and C₄ when used in a hybrid catalyst on Cu—Zn—Al methanol synthesis catalyst and Y zeolite in the direct synthesis of hydrocarbons from syngas for example as reported by Ma X, et al. Chinese Journal of Chemical, 2010, Vol 31, No 12, 1501˜1506.

The average pore size of the SAPO may be at least 0.7 nm. For examples in which the target products include LPG, the average pore size of the SAPO may preferably be at least 0.7 nm. In other examples where other hydrocarbons are target products a small pore size may be used. Information regarding pore sizes of SAPOs may be obtained for example from the database of zeolite structures provided by the Structure Commission of the International Zeolite Association.

In some examples, the SAPO molecular sieve may comprise more than one SAPO composition, for example as a mixture, for example a mixture of SAPO-5 and SAPO-37. In other examples, the SAPO composition may comprise substantially only one type of SAPO composition, for example SAPO-5. The proportion of SAPO-5 in the SAPO composition may for example be more than 10 wt %, for example more than 50 wt %, or more than 70 wt %. The proportion of SAPO-5 in the SAPO composition may be for example less than 90 wt. The SiO₂/Al₂O₃ ratio in the SAPO may be between from about 0.1 to 15. In some examples, the ratio may be between from about 0.3 to 3.

The metal M may comprise any suitable active metal, for example having activity for hydrogenation in the M-SAPO composition. The metal M comprises one or more metals selected from the group comprising Pt, Pd, Rh and Cu. In some preferred examples, the metal M includes Pd.

The metal M will be present in a suitable amount for the required activity of the M-SAPO catalyst. The metal M may for example be present at about 0.001-2 wt % in the M-SAPO, for example where the metal M is Pd. The weight percent of M in the dehydration/hydrogenation catalyst may be between from about 0.001-2 wt %. For example the weight percent of M in the dehydration/hydrogenation catalyst is between from about 0.01-1 wt %.

The carbon oxide(s) conversion catalyst preferably comprises a carbon oxide(s) hydrogenation component. The carbon oxide(s) conversion catalyst may comprise a methanol conversion catalyst.

The carbon oxide(s) conversion catalyst may include Cu, Zn and/or Cr, or Pd. For example, the carbon oxide(s) conversion catalyst may comprise one or more compositions selected from Cu—ZnO-[Sup], Pd-[Sup] and Zn—Cr-[Sup] where [Sup] is a support composition. The support composition may for example comprise Al₂O₃ and/or SiO₂ and/or a zeolite.

The weight percent of M-SAPO in the catalyst composition may be is between from about 20 to 80%. In some examples, the amount of the M-SAPO hydrogenation/dehydration catalyst in the catalyst composition is between from about 40 to 70%,

According to a further aspect of the invention there is provided a method of preparing a catalyst composition for use in the conversion of carbon oxide(s) to saturated hydrocarbons, the catalyst composition comprising:
a) modifying a SAPO molecular sieve by addition of a metal M to produce an M-SAPO composition;
b) mixing the M-SAPO composition with a carbon oxide(s) conversion catalyst.
   The metal M may be added to the SAPO by an ion-exchange method or by an impregnation method.

Following the addition of the metal to the SAPO, the composition may be heated. Thus the method may further include the step of heat treating the M-SAPO composition at a temperature between from 400° C. to 600° C. The heating may be carried out in some examples at a temperature between from about 500° C. to about 550° C. The heat treatment may comprise a calcination step.

The mixing of the carbon oxide(s) conversion catalyst and the M-SAPO may be carried out using any appropriate method, for example mechanical mixing.

Therefore, the invention may provide multifunctional catalysts prepared by mechanical mixing of CO hydrogenation active components, with dehydration components modified by metal active components.

The weight percent of M-SAPO mixed with the carbon oxide(s) conversion catalyst may be between from about 20 to 80%. In some examples, the proportion of M-SAPO and the carbon oxide(s) conversion catalyst may be chosen such that the mixing produces a catalyst composition having a wt % of the M-SAPO of between from 40 to 70%.

Features of the catalyst composition aspect of the invention may be applied to this method aspect of the invention. In preferred examples of this aspect of the invention, the SAPO molecular sieve comprises SAPO-5.

The metal M may comprise one or more metals selected from the group comprising Pt, Pd, Rh and Cu.

The invention also provides a catalyst composition prepared by a method described herein. Thus in examples of aspects of the present invention, the catalyst composition comprises a hybrid or multifunctional catalyst including CO hydrogenation active components, with dehydration components modified by metal active components.

Alternatively, and according to examples of a further aspect of the invention, the components of the catalyst might be provided in separate reaction stages. For example, the carbon oxide(s) conversion catalyst might be provided separately from the M-SAPO component. Thus a further aspect of the invention provides a catalyst system for use in the conversion of carbon oxide(s) to saturated hydrocarbons, the catalyst system comprising:
a) a carbon oxide(s) conversion catalyst component; and
b) a dehydration/hydrogenation catalyst component comprising a silicoalumino phosphate (SAPO) molecular sieve and a metal M.

The components of the system may include one or more features of other aspects of the invention described herein. In a preferred example, the SAPO comprises SAPO-5.

The components of the catalyst system may be provided independently. Thus a further aspect of the invention provides a dehydration/hydrogenation catalyst component for use in the production of saturated hydrocarbons, the catalyst component comprising a silicoalumino phosphate (SAPO) molecular sieve and a metal M.

By separating the conversion into two reaction stages, the reaction conditions and other parameters of the two stages can be optimized independently.

Also provided by an aspect of the invention is a method of producing saturated hydrocarbons using a catalyst composition or catalyst system as described herein.

According to an aspect of the invention there is provided a process for the generation of saturated hydrocarbons from carbon oxide(s) and hydrogen, the process comprising the steps of feeding a gas feed stream including carbon oxide(s) and hydrogen to a reaction system including a catalyst composition comprising a carbon oxide(s) conversion catalyst; and a dehydration/hydrogenation catalyst comprising a silicoalumino phosphate (SAPO) molecular sieve and a metal M, wherein at least a portion of the gas feed stream is converted to saturated hydrocarbons.

The catalyst composition may comprise a catalyst composition described herein and/or a catalyst composition prepared according to a method described herein.

The temperature of the reaction system may be between from about 280° C. to 370° C. In examples of the invention, the temperature of the reaction system may be between from about 320° C. to 350° C. Without wishing to be bound to any particular theory, it is believed that the reaction temperature will affect the selectivity to hydrocarbons in the reaction. In some examples, reaction temperatures between from about 280° C. to 370° C. may favour hydrocarbons including C₃ and C₄ hydrocarbons, and therefore may be a preferred reaction temperature where the target product includes LPG. In other examples, for example where the target product is higher hydrocarbons, for example gasoline fraction, a different reaction temperature may be preferred. For example, the preferred reaction temperature may be at least 250° C.

In examples of the invention, the reaction temperature may be measured as the temperature of the catalyst composition. In examples of the invention where the catalyst composition is provided in a catalyst bed, the temperature of the catalyst composition may vary across the bed. Preferably, in such cases, the reaction temperature is measured as the average temperature of the catalyst composition.

The pressure of the feed stream may be between from about 5 to 50 bar. In examples of the invention, the pressure of the feed stream may be between from about 15 to 40 bar. The pressure of the reaction system may be from about 5 to 50 bar, for example from about 15 to 40 bar.

In examples of the invention, the reaction pressure is between about 10 and 40 bar. In examples of the invention, the reaction may be carried out at about 30 bar.

The gas space velocity of the reaction system is between from 300 to 15000 h⁻¹. For example, the gas space velocity may be between from 500 to 3000 h⁻¹. Preferably the gas space velocity is defined as the number of bed volumes of gas passing over the catalyst bed at standard temperature and pressure.

In preferred examples the process is a gas phase process.

The feed to the process comprises carbon oxide(s) and hydrogen. Any appropriate source of carbon oxides (for example carbon monoxide and/or carbon dioxide) and of hydrogen may be used for example natural gas, coal and/or biomass. Processes for producing mixtures of carbon oxide(s) and hydrogen are well known. Each method has its advantages and disadvantages, and the choice of using a particular reforming process over another is normally governed by economic and available feed stream considerations, as well as by the desire to obtain the desired (H₂—CO₂):(CO+CO₂) molar ratio in the resulting gas mixture, that is suitable for further processing. Synthesis gas as used herein preferably refers to mixtures containing carbon dioxide and/or carbon monoxide with hydrogen. Synthesis gas may for example be a combination of hydrogen and carbon oxides produced in a synthesis gas plant from a carbon source such as natural gas, petroleum liquids, biomass and carbonaceous materials including coal, recycled plastics, municipal wastes, or any organic material. The synthesis gas may be prepared using any appropriate process for example partial oxidation of hydrocarbons (PDX), steam reforming (SR), advanced gas heated reforming (AGHR), microchannel reforming (as described in, for example, U.S. Pat. No. 6,284,217), plasma reforming, autothermal reforming (ATR) and any combination thereof.

A discussion of these synthesis gas production technologies is provided for in “Hydrocarbon Processing” V78, N. 4, 87-90, 92-93 (April 1999) and/or “Petrole et Techniques”, N. 415, 86-93 (July-August 1998), which are both hereby incorporated by reference.

The synthesis gas source used in the present invention preferably contains a molar ratio of (H₂—CO₂):(CO+CO₂) ranging from 0.6 to 2.5. The gas composition which the catalyst is exposed to will generally differ from such a range due to for example gas recycling occurring within the reaction system. For example, in commercial methanol plants, a syngas feed molar ratio (as defined above) of 2:1 is commonly used, whereas the catalyst may experience a molar ratio of greater than 5:1 due to recycle. The gas composition experienced by the catalyst may initially be for example between from about 0.8 to 7, for example from about 2 to 3.

The carbon oxide(s) conversion catalyst is preferably active to produce methanol as a first stage of the reaction. Thus the catalyst composition may include a methanol conversion catalyst. An intermediate product may therefore include methanol. The M-SAPO preferably has dehydration/hydrogenation catalyst activity for the production of saturated hydrocarbons.

The carbon oxide(s) conversion catalyst may in addition, or alternatively, be active to produce dimethyl ether (DME) in a first reaction stage. In some examples, both methanol and DME are produced; thus intermediate products may include DME and/or methanol. Direct syngas-to-DME processes have also been developed. These processes are thought to proceed via a methanol intermediate which is etherified by an added acid functionality in the catalyst, for example as described in PS Sai Prasad, et al., Fuel Processing Technology Volume 89, Issue 12, December 2008, p 1281-1286.

The conversion of methanol or DME to higher olefins may then be catalysed by a SAPO acidic support. Chain growth from the DME to the corresponding higher olefins occurs prior to hydrogenation in the presence of the metal M to produce the desired C₃ and higher hydrocarbon products.

The process may further include the step of carrying out a regeneration of catalyst. It is known that the MTO, MTP and MTG processes require frequent regeneration of the catalysts. One source of deactivation of the catalyst is the build up of coke formed on the catalysts during the reaction. One way of removing such coke build up is by a controlled combustion method. Other methods include washing of the catalyst to remove the coke using for example aromatic solvent.

The process may further include the step of carrying out a regeneration treatment, the regeneration treatment including heating the M-SAPO composition to a temperature of at least 500° C. The regeneration of the catalyst may include heating the catalyst, for example to a temperature of at least 500° C. The temperature of the regeneration treatment may be for example at least 500° C., preferably at least 550° C., for example 580° C. or more. It will be understood that a high temperature of treatment will be desirable to burn off the coke, but that very high temperatures will not be preferred in some cases because of the risk of reducing significantly the performance of the catalyst, for example due to metal sintering and/or SAPO thermal stability problems.

The regeneration of the catalyst may have added complexity where a metal is present in the catalyst as this can be affected adversely during the regeneration process. For example, the metal may sinter if a high temperature method is used. However, such sintered metals can be redispersed by an appropriate method such as treatment with carbon monoxide.

Where the carbon oxide(s) catalyst may be affected adversely during the regeneration process, for example if it includes a metal sensitive to sintering (for example Cu), the carbon oxide(s) catalyst may be separated from the M-SAPO composition prior to the regeneration treatment being carried out on the M-SAPO. In alternative methods, the heat treatment may be carried out on the hybrid catalyst.

A further aspect of the invention provides apparatus for use in a process for the generation of saturated hydrocarbons from carbon oxide(s) and hydrogen, the apparatus including a catalyst bed including a catalyst composition comprising a carbon oxide(s) conversion catalyst; and a dehydration/hydrogenation catalyst comprising a silicoalumino phosphate (SAPO) molecular sieve and a metal M.

The catalyst bed may include any appropriate catalyst bed type, for example fixed bed, fluidized bed or moving bed. A moving bed or paired bed system, for example a swing bed system, may be preferred where catalyst regeneration is desirable.

Also provided by the invention is a saturated hydrocarbon product produced by a process as described herein.

The product hydrocarbons preferably include iso-butane, wherein the proportion of iso-butane is preferably more than 60% by weight of the C₄ saturated hydrocarbons in the product. The fraction of C₄ and higher hydrocarbons produced is preferably has a high degree of branching. This can be beneficial for applications in LPG, for example giving a reduced boiling point of the C₄ fraction, and/or for C₅ and higher hydrocarbons for octane number in gasoline. In addition, the use the product LPG including propane and iso-butane as a chemical feedstock to generate the corresponding olefins is preferable in some cases to using propane and n-butane. While examples of the invention have been described herein relating to the production of LPG, in other examples, target hydrocarbons include butane (C₄) and higher hydrocarbons.

Many known syngas conversion processes are disadvantageous due to a low selectivity for the target product. One by-product which acts as a significant hydrogen sink is methane. The formation of methane can have a negative effect on the economics of the process. For example, Fischer Tropsch chemistry to produce diesel and alkanes typically produces more than 10% methane.

Preferably the molar fraction of methane in the total saturated hydrocarbons produced is less than 10%. Preferably the molar fraction of ethane in the total saturated hydrocarbons produced is less than 25%.

Thus examples of the invention provide a multifunctional catalyst for syngas to liquefied petroleum gas conversion which includes CO hydrogenation active components, dehydration components comprising a SAPO molecular sieve, and metal active components. In examples of aspects of the invention, the catalysts have been found to exhibit relatively high conversion and LPG hydrocarbon distribution. In some examples, greater than 70% conversion and greater than 70% LPG selectivity in hydrocarbons could be obtained at reaction temperatures of between from 280 to 330° C., and reaction pressure between from 1.0 to 4.0 MPa.

Examples of the invention provide a catalyst comprising a Cu—ZnO—Al₂O₃ CO hydrogenation catalyst with metal-modified SAPO-5 molecular sieves providing a dehydration and olefin hydrogenation component. Also provided are methods for LPG production from synthesis gas.

The invention extends to methods and/or apparatus and/or processes and/or compositions substantially as herein described with reference to the accompanying drawings.

Any feature in one aspect of the invention may be applied to other aspects of the invention, in any appropriate combination. In particular, features of method aspects may be applied to apparatus aspects, and vice versa.

Preferred features of the present invention will now be described, purely by way of example.

In the following examples, example catalysts were prepared and then tested in a process for conversion of syngas to saturated hydrocarbons.

In the results of catalytic test, the carbon oxide(s) (CO) conversion, Selectivity to Hydrocarbons and CO₂, Hydrocarbon yield and hydrocarbon distribution were determined. In relation to the following examples, those parameters were defined as follows:

CO conversion (% mol)=CO_{Converted}/(CO_{Converted}+CO_{unconverted})×100%

Selectivity to hydrocarbons (mol % C)=CO_{hydrocarbons}/CO_{converted}×100%

Hydrocarbon Yield (mmol C·g cat⁻¹·h⁻¹)=CO in feed gases×CO conversion×selectivity to hydrocarbons

Hydrocarbon distribution (mol % C)=CO_{Ci}/ΣCO_{Ci}×100%

LPG yield (mmol C·g cat⁻¹·h¹)=Hydrocarbon yield×CO_{LPG}/ΣCO_{LPG}

In the above formulae, CO_{Converted}, CO_{unconverted}, CO_{hydrocarbons}, CO_{Ci}, CO_{LPG} means, in respect of the conversion reaction, converted CO molar, unconverted CO molar, CO molar converted to hydrocarbons, CO molar converted to Cᵢ (i=1, 2 . . . ) hydrocarbons, CO molar converted to LPG, respectively.

where CO_{Converted} and CO_{unconverted} represent the % mol of converted and unconverted carbon oxide(s) in the product stream, respectively.

### Preparation of Pd-Modified SAPO

For the following examples, metal-modified SAPO compositions were prepared using an ion-exchange method. For example, a Pd-modified SAPO-5 composition was prepared by the following method. 10 g SAPO-5 (synthesized according to reported methods, for example Wang L et al, Microporous and Mesoporous Materials, 2003, Vol 64, 63˜68) was added to a 200 ml solution of PdCl₂ at 60° C. with stirring, and maintained for 8 h, and then washed with water, dried at 120° C. and calcined at 550° C.

### EXAMPLE 1

15 g commercial carbon oxide(s) conversion catalyst Cu—ZnO—Al₂O₃ (from Shenyang Catalyst Corp.) was mixed with 7.5 g Pd-modified SAPO-5. The multifunctional catalyst produced was identified as catalyst A.

### EXAMPLE 2

15 g commercial methanol synthesis catalyst Cu—ZnO—Al₂O₃ (from Shenyang Catalyst Corp.) was mixed with 15 g Pd-modified SAPO-5. The multifunctional catalyst produced was identified as catalyst B.

### EXAMPLE 3

7.5 g commercial methanol synthesis catalyst Cu—ZnO—Al₂O₃ (from Shenyang Catalyst Corp.) was mixed with 15 g Pd-modified SAPO-5. The multifunctional catalyst produced was identified as catalyst C.

### EXAMPLE 4

To compare catalysts including SAPO-5 with the catalysts containing other molecular sieves, a multifunctional catalyst including Cu—ZnO—Al₂O₃/Pd-SAPO-11 was prepared. 15 g commercial methanol synthesis catalysts Cu—ZnO—Al₂O₃ (from Shenyang Catalyst Corp.) was mixed with 7.5 g Pd-modified SAPO-11, the multifunctional catalyst was identified as catalyst D.

### CONVERSION EXPERIMENTS

The catalyst samples prepared according to Examples 1 to 4 above were used to evaluate their use in the catalytic conversion of synthesis gas to LPG and other saturated hydrocarbons. A single-stage reaction system with fixed catalyst bed under pressurized conditions was used. The catalyst was first reduced at 200° C. to 300° C. for between 2 and 8 hours in a hydrogen flow. Subsequently, syngas was fed to the reaction vessel and the reaction carried out using different reaction conditions as described below.

The product stream was analysed using gas chromatography (GC) apparatus. CO, CO₂, CH₄ and N₂ were analysed using a GC equipped with a thermal conductivity detector (TCD); organic compounds were analysed using another GC apparatus equipped with a flame ionization detector (FID).

### Experiment 1

The reaction conditions were

Temperature: 335° C.

Pressure: 3.0 MPa

Gas space velocity: 1500 h⁻¹

Feed gas composition (% mol): 63.8% H₂, 32.0% CO, 4.16% N₂.

The results are listed in Tables 1 and 2.

TABLE 1
Reaction performances of catalyst samples for syngas to LPG

| | CO | | | | | Hydrocarbon Yield |
|---|---|---|---|---|---|---|
| Catalyst | conversion, | Selectivity (mol C %) | | | | (mmol C · |
| sample | % | CO₂ | CH₃OH | DME | HCs | g cat ⁻¹ · h⁻¹ |
| A | 74.2 | 42.0 | 0.1 | 0.4 | 57.5 | 9.15 |
| B | 73.0 | 39.9 | 0.0 | 0.0 | 60.0 | 9.39 |
| C | 73.9 | 42.1 | 0.0 | 0.2 | 57.7 | 9.13 |
| D | 36.4 | 40.4 | 0.2 | 20.0 | 39.4 | 3.07 |

TABLE 2
Reaction performances of catalyst samples for syngas to LPG

| | | | | | | | LPG/ | LPG Yield |
|---|---|---|---|---|---|---|---|---|
| | Hydrocarbon distribution | | | | | | HCs | (mmol C · |
| Catalyst | (C mol %) | | | | | | (C mol | g cat ⁻¹ · |
| sample | C₁ | C₂ | C₃ | C₄ | C₅ | C₆₊ | %) | h⁻¹) |
| A | 5.1 | 6.5 | 14.9 | 44.4 | 17.8 | 11.4 | 59.3 | 5.42 |
| B | 4.9 | 4.6 | 17.6 | 52.8 | 13.4 | 6.6 | 70.4 | 6.61 |
| C | 3.7 | 3.6 | 16.3 | 56.7 | 13.6 | 6.2 | 73.0 | 6.66 |
| D | 22.0 | 14.0 | 16.9 | 15.0 | 13.2 | 19.0 | 31.9 | 0.98 |

It can be seen from Tables 1 and 2 that catalysts A, B and C not only show higher CO conversion (>70%), but also exhibit the higher LPG yield (greater than 6 mmol C·gcat⁻¹·h⁻¹) in these examples. Catalyst D was seen to exhibit lower CO conversion, LPG selectivity and LPG yield (1.0 mmol C·g cat⁻¹·h⁻¹).

Without wishing to be bound by any particular theory, it is thought that the advantageous reaction performance of the catalysts including SAPO-5 was at least in part related to the pore structure of SAPO in relation to molecular size. SAPO-5 has a generally uni-dimensional pore system consisting of cylindrical channels formed by 12-membered rings with a diameter of 0.8 nm. It is thought that such a size is a suitable size for LPG hydrocarbon formation: C₃ and C₄ hydrocarbons. In comparison, SAPO-11 has one dimensional 10-membered-ring medium-sized pore channel. The pore size of SAPO-11 is about 0.39×0.64 nm, which is thought to favour the formation of methane and ethane.

### Experiment 2

The conversion reaction tests using catalyst B were carried out to investigate the effects of feed gas space velocity on the reaction. For this experiment, the reaction conditions were:

Temperature 335° C.; pressure 2.0 MPa; Feed gas composition (% mol): 63.8% H₂, 32.0% CO, 4.16% N₂. The results are listed in Tables 3 and 4.

TABLE 3
Effect of gas hourly space velocity (GHSV) on reaction
performances over catalyst B

| | CO | | | | | Hydrocarbon Yield |
|---|---|---|---|---|---|---|
| | conversion, | Selectivity (mol C %) | | | | (mmol C · |
| GHSV | % | CO₂ | CH₃OH | DME | HCs | g cat ⁻¹ · h⁻¹) |
| 500 | 67.0 | 39.5 | 0.0 | 0.0 | 60.5 | 2.89 |
| 1000 | 60.3 | 39.9 | 0.0 | 0.1 | 59.9 | 5.16 |
| 1500 | 56.0 | 39.8 | 0.0 | 0.2 | 60.0 | 7.21 |
| 2500 | 44.7 | 40.4 | 0.0 | 0.4 | 59.3 | 9.46 |
| 3500 | 35.0 | 40.6 | 0.0 | 0.7 | 58.7 | 10.26 |
| 4500 | 31.3 | 40.7 | 0.1 | 1.0 | 58.2 | 11.69 |

TABLE 4
Effect of GHSV on hydrocarbon distribution and LPG yield
over catalyst B

| | Hydrocarbon distribution | | | | | | | LPG Yield |
|---|---|---|---|---|---|---|---|---|
| GHSV | (C mol %) | | | | | | LPG/HCs | (mmol · |
| h⁻¹ | C₁ | C₂ | C₃ | C₄ | C₅ | C₆₊ | (C mol %) | g cat ⁻¹ · h⁻¹) |
| 500 | 8.7 | 5.3 | 18.1 | 52.2 | 11.1 | 4.5 | 70.3 | 2.04 |
| 1000 | 6.9 | 4.7 | 16.7 | 52.8 | 12.5 | 6.3 | 69.5 | 3.59 |
| 1500 | 6.9 | 5.0 | 16.3 | 51.4 | 13.1 | 7.4 | 67.7 | 4.88 |
| 2500 | 6.0 | 4.2 | 15.3 | 52.4 | 13.8 | 8.4 | 67.7 | 6.41 |
| 3500 | 5.7 | 3.7 | 15.3 | 52.8 | 13.9 | 8.7 | 68.1 | 6.98 |
| 4500 | 5.6 | 3.6 | 15.0 | 52.3 | 14.4 | 9.2 | 67.3 | 7.87 |

It could be identified from Tables 3 and 4 that, with increasing the feed gas space velocity from 500 to 4500 h⁻¹, CO conversion decreases from 67% to 31.3%, LPG selectivity in hydrocarbons is almost stable, however, the yield of LPG increased from 2.04 to 7.87 mmol·g cat⁻¹·h⁻¹. Without wishing to be bound by any particular theory, it is believed that in this example, with increase in the feed gas space velocity, the residence time on the catalyst become short and therefore some secondary reactions, for example dehydration reactions and heavy hydrocarbon cracking reactions, became less. Thus it is thought that this would result in the decrease of CO conversion, and light hydrocarbons become less and heavy hydrocarbons become more in the product distribution. Thus a high gas space velocity may have a role for methods of conversion to higher hydrocarbons, for example including gasoline fractions.

### Experiment 3

The conversion reaction tests using catalyst B were carried out for investigating the influences of feed gas pressure on the reaction. In this example, the reaction conditions were: temperature 335° C., GSV 1500 h⁻¹; Feed gas composition (% mol): 63.8% H₂, 32.0% CO, 4.16% N₂. The results are listed in Tables 5 and 6.

TABLE 5
Effect of reaction pressure on reaction performances over
catalyst B

| | CO | | | | | Hydrocarbon Yield |
|---|---|---|---|---|---|---|
| P | conversion, | Selectivity (mol C %) | | | | (mmol · |
| MPa | % | CO₂ | CH₃OH | DME | HCs | g cat ⁻¹ · h⁻¹) |
| 1.0 | 27.7 | 39.9 | 0.0 | 0.6 | 59.6 | 3.53 |
| 2.0 | 56.0 | 39.8 | 0.0 | 0.2 | 60.0 | 7.21 |
| 3.0 | 73.0 | 39.9 | 0.0 | 0.0 | 60.0 | 9.39 |
| 4.0 | 79.7 | 39.8 | 0.0 | 0.0 | 60.2 | 10.29 |

TABLE 6
Effect of reaction pressure on hydrocarbon distribution and LPG
yield over catalyst B

| | Hydrocarbon distribution | | | | | | | LPG Yield |
|---|---|---|---|---|---|---|---|---|
| P | (C mol %) | | | | | | LPG/HCs | (mmol · |
| MPa | C₁ | C₂ | C₃ | C₄ | C₅ | C₆₊ | (C mol %) | g cat ⁻¹ · h⁻¹) |
| 1.0 | 15.5 | 7.3 | 16.3 | 43.9 | 10.9 | 6.1 | 60.2 | 2.13 |
| 2.0 | 6.9 | 5.0 | 16.3 | 51.4 | 13.1 | 7.4 | 67.7 | 4.88 |
| 3.0 | 4.9 | 4.6 | 17.6 | 52.8 | 13.4 | 6.6 | 70.4 | 6.61 |
| 4.0 | 5.1 | 5.1 | 18.2 | 51.3 | 13.6 | 6.7 | 69.5 | 7.15 |

It could be seen from Tables 5 and 6 that with increasing reaction pressure from 1.0 MPa to 4.0 MPa, CO conversion increases from 27.7% to 79.7%, LPG selectivity in hydrocarbons slightly increases first to a high value (70.4%) at 3.0 MPa, and then slightly decreases, however, the yield of LPG increased from 2.13 to 7.15 mmol·g cat⁻¹·h⁻¹. Syngas to LPG via DME is an equilibrium reaction with the forward reaction involving reduction in volume. It is therefore beneficial to moving the equilibrium to the forward reaction to increase the reaction pressure. It is also noted that selectivity to CO₂ and hydrocarbons is almost stable with increasing pressure over catalyst B. In respect of the hydrocarbon distribution, the proportion of light hydrocarbons reduces and that of heavy hydrocarbons increases with increasing reaction pressure. This indicates that low pressure is beneficial to the formation of the light hydrocarbons while high pressure is more beneficial to the production of heavy hydrocarbons. For LPG production, including propane and butane, it is seen that for this example, an advantageous reaction pressure is about 3.0 MPa for syngas to LPG conversion over catalyst B. For other examples, for example including the production of higher hydrocarbons, higher reaction pressures may be desirable.

### Experiment 4

The conversion reaction tests using catalyst B were carried out to investigate the effect of reaction temperature on the reaction. The reaction conditions were: reaction pressure 2.1 MPa, GSV 1500 h⁻¹; Feed gas composition (% mol): 63.8% H₂, 32.0% CO, 4.16% N₂. The results are listed in Tables 7 and 8.

TABLE 7
Effect of reaction temperature on reaction performances over
catalyst B

| | CO | | | | | Hydrocarbon Yield |
|---|---|---|---|---|---|---|
| Temp. | conversion, | Selectivity (mol C %) | | | | (mmol C · |
| ° C. | % | CO₂ | CH₃OH | DME | HCs | g cat ⁻¹ · h⁻¹) |
| 230 | 34.3 | 28.0 | 0.5 | 68.6 | 2.9 | 0.21 |
| 265 | 48.6 | 30.8 | 0.4 | 52.0 | 16.8 | 1.75 |
| 300 | 65.6 | 40.0 | 0.0 | 0.4 | 59.6 | 8.38 |
| 335 | 60.7 | 40.8 | 0.0 | 0.2 | 58.9 | 7.66 |
| 370 | 44.5 | 40.8 | 0.0 | 0.1 | 59.1 | 5.63 |

TABLE 8
Effect of reaction temperature on reaction performances over
catalyst B

| | | | | | | | LPG/ | |
|---|---|---|---|---|---|---|---|---|
| | Hydrocarbon distribution | | | | | | HCs | LPG Yield |
| Temp. | (C mol %) | | | | | | (C mol | (mmol · |
| ° C. | C₁ | C₂ | C₃ | C₄ | C₅ | C₆₊ | %) | g cat ⁻¹ · h⁻¹) |
| 230 | 5.8 | 2.4 | 6.2 | 56.7 | 29.0 | 0.0 | 62.9 | 0.13 |
| 265 | 2.3 | 1.1 | 2.9 | 40.8 | 22.7 | 30.2 | 43.7 | 0.65 |
| 300 | 4.3 | 5.3 | 14.0 | 47.6 | 18.8 | 10.0 | 61.6 | 5.15 |
| 335 | 9.4 | 6.0 | 17.4 | 49.3 | 12.1 | 5.8 | 66.7 | 5.10 |
| 370 | 23.8 | 11.6 | 23.7 | 32.3 | 6.9 | 1.8 | 56.0 | 3.15 |

It can be seen from Tables 7 and 8 that with increasing reaction temperature from 230° C. to 370° C., CO conversion increases, reaching a maximum at about 300° C. For the products, DME is the main product below 265° C. and hydrocarbons are the main products above 300° C., LPG is the main product in the hydrocarbon products. With reaction temperature increasing, methane and ethane production increases, the production of heavy hydrocarbons (C₅-C₆₊) becoming less especially at temperatures greater than 335° C. In this example, a favourable LPG yield could be obtained at a reaction temperature of about 300 to 335° C.

The conversion reaction includes reaction steps such as: syngas to DME; DME to hydrocarbons; amongst others. At low temperature, syngas to DME is thought to be the main reaction, and with temperature increasing, DME dehydration increases giving a product stream including a higher proportion of products resulting from DME to hydrocarbon conversion (for example LPG).

If the target products include higher hydrocarbons, a lower reaction temperature may be favoured.

The test for the conversion of synthesis gas to LPG in these tests showed the following preferred reaction conditions: reaction temperature of the multifunctional catalysts was between from 280° C. and 370° C., for example between from 320° C. and 350° C. The reaction pressure was between from 5 to 50 bar, for example between from 15 to 30 bar. The gas space velocity of the multifunctional catalysts was between from 300 to 5000 h⁻¹, for example between from 500 to 3000 h⁻¹. The ratio of H₂ to CO was between from 0.8 to 7, for example between from 1.5 to 3.

It will be understood that the present invention has been described above purely by way of example, and modification of detail can be made within the scope of the invention. Each feature disclosed in the description, and (where appropriate) the claims and drawings may be provided independently or in any appropriate combination.

1-30. (canceled)

31. A catalyst composition for use in the conversion of carbon oxide(s) to saturated hydrocarbons, the catalyst composition comprising:
a) a carbon oxide(s) conversion catalyst; comprising a methanol synthesis catalyst;
b) a dehydration/hydrogenation catalyst comprising a silicoalumino phosphate (SAPO) molecular sieve and a metal M.

32. A catalyst composition for use in the conversion of carbon oxide(s) to saturated hydrocarbons, the catalyst composition comprising:
a) a carbon oxide(s) conversion catalyst; and
b) a dehydration/hydrogenation catalyst comprising a silicoalumino phosphate (SAPO) molecular sieve and a metal M.

33. A catalyst composition according to claim 32, wherein the SAPO molecular sieve comprises SAPO-5.

34. A catalyst composition according to claim 32 wherein the SAPO molecular sieve comprises SAPO-37.

35. A catalyst composition according to claim 32 wherein the dehydration/hydrogenation catalyst comprises a SAPO having an average pore size of at least 0.7 nm.

36. A catalyst composition according to claim 35, wherein the dehydration/hydrogenation catalyst comprises a SAPO having an average pore size of at least 0.73 nm.

37. A catalyst composition according to claim 32, wherein the Si02/A1203 ratio in the SAPO is between from about 0.1 to 15.

38. A catalyst composition according to claim 32, wherein the metal M comprises one or more metals selected from the group comprising Pt, Pd, Rh and Cu.

39. A catalyst composition according to claim 38, wherein the metal M includes Pd.

40. A catalyst composition according to claim 32, wherein the weight percent of M in the dehydration/hydrogenation catalyst is between from about 0.001-2 wt %.

41. A catalyst composition according to claim 32, wherein the carbon oxide(s) conversion catalyst comprises a methanol conversion catalyst.

42. A catalyst composition according to claim 32, wherein the carbon oxide(s) conversion catalyst comprises one or more compositions selected from Cu—ZnO-[Sup], Pd-[Sup] and Zn—Cr-[Sup] where [Sup] is a support composition.

43. A catalyst composition according to claim 32, wherein the weight percent of M-SAPO in the catalyst composition is between from about 20 to 80%.

44. A method of preparing a catalyst composition for use in the conversion carbon oxide(s) to saturated hydrocarbons, the catalyst composition comprising:
a) modifying a SAPO molecular sieve by addition of a metal M to produce an M-SAPO composition.
b) mixing the M-SAPO composition with a carbon oxide(s) conversion catalyst.

45. A method according to claim 44, wherein the metal M is added to the SAPO by an ion-exchange method.

46. A method according to claim 44, wherein the metal M is added to the SAPO by an impregnation method.

47. A method according to claim 44, further including the step of heat treating the M-SAPO composition at a temperature between from 400° C. to 600° C.

48. A method according to claim 44 wherein the weight percent of M-SAPO mixed with the carbon oxide(s) conversion catalyst is between from about 20 to 80%.

49. A method according to claim 44 wherein the SAPO molecular sieve comprises SAPO-5.

50. A method according to claim 44 wherein the metal M comprises one or more metals selected from the group comprising Pt, Pd, Rh and Cu.

51. A process for the generation of saturated hydrocarbons from carbon oxide(s) and hydrogen, the process comprising the steps of feeding a gas feed stream including carbon oxide(s) and hydrogen to a reaction system including a catalyst composition comprising a carbon oxide(s) conversion catalyst; and a dehydration/hydrogenation catalyst comprising a silicoalumino phosphate (SAPO) molecular sieve and metal M, wherein at least a portion of the gas feed stream is converted to saturated hydrocarbons.

52. A process according to claim 51, wherein the catalyst composition comprises a catalyst composition as defined above, or a catalyst composition prepared as defined above.

53. A process according to claim 51, wherein the temperature of the reaction system is between from about 280° C. to 370° C.

54. A process according to claim 51 wherein the pressure of the feed stream is between from about 5 to 50 bar.

55. A process according to claim 51 wherein gas space velocity of the reaction system is between from 300 to 15000 h⁻¹.

56. A process according to claim 51 further including carrying out a regeneration treatment, the regeneration treatment including heating the M-SAPO compostion to a temperature of at least 500° C.

57. A process according to claim 51 for the generation of saturated C3 and higher hydrocarbons form carbon oxide(s) and hydrogen, wherein the dehydration/hydrogenation catalyst comprises a SAPO having an average pore size of at least 0.7 nm.

58. A process according to claim 57, wherein the dehydration/hydrogenation catalyst comprises a SAPO having an average pore size of at least 0.73. nm.

59. A hydrocarbon product produced by a process according to claim 51.

60. Apparatus for use in a process for the generation of saturated hydrocarbons from carbon oxide(s) and hydrogen, the apparatus including a catalyst bed including a catalyst composition comprising a carbon oxide(s) conversion catalyst and a dehydration/hydrogenation catalyst comprising a silicoalumino phosphate (SAPO) molecular sieve and a metal M.
